(19) United States
(12) Patent Application Publication
(10) Pub. No.: US 2007/0187531 A1
(43) Pub. Date: Aug. 16, 2007

(54) Apparatus and method to amalgamate substances

(75) Inventors: Joseph E. Wolfe, Richboro, PA (US); Jonathan W. Kaufman, Leonardtown, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The U.S. of America as represented by the Secretary of the Navy

(21) Appl. No.: 11/357,460

(22) Filed: Feb. 14, 2006

(51) Int. Cl. B05B 7/12

(52) U.S. Cl. 239/413; 239/418; 239/304; 239/407

(57) ABSTRACT

An apparatus to amalgamate substances which includes at least two substance holding tanks, an inert gas tank, an amalgamation mixing chamber, and a nozzle. The inert gas tank is in fluid communication with the at least two substance holding tanks such that when actuated, inert gas will further pressurize substances contained in the at least two substance holding tanks. The amalgamation mixing chamber is in fluid communication with the at least two substance holding tanks such that when actuated, the substances in the at least two substance holding tanks enter and mix in the amalgamation mixing chamber. The nozzle is in fluid communication with the amalgamation mixing chamber such that when actuated, the mixed substances in the amalgamated mixing chamber are discharged from the nozzle.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to an apparatus and method to amalgamate substances. More specifically, but without limitation, the present invention relates to a fine mist fire protection/suppression system for fire extinguishment.

Fluorocarbon-based and Halon fire extinguishants are environmentally harmful because they cause depletion of the earth's ozone layer. Present U.S. law and treaty requires the phase out and replacement of such materials under the 1988 Montreal Protocol. The 1988 Montreal Protocol classified Halon as a Class I Ozone Depleting Substance (ODS), and called for limits on global production by over 100 developed nation signatories. Furthermore, the U.S. Clean Air Act Amendments of 1990 call for the ban on production of Halon in the U.S after January 1994. This law also prohibits purposeful venting and requires training personnel involved with their use to minimize their emission into the atmosphere. The U.S. Navy has responded to the requirements of these acts by prospectively prohibiting the use of ozone depleting substances and by finding and using alternative designs in fire extinguishment systems. Therefore, a need exists to replace all Halon systems, specifically for hand held fire protection/suppression systems, which currently use Halons or CO₂ (Halon being an ozone-depleting chemical and CO₂ acting as a global warming agent). In addition, a need exists for replacing all Halon systems and improving existing water sprinkler based systems for more effective fire extinguishment use. Halon cannot be employed in any new military systems, except via a waiver. All new civilian uses of Halon have been banned, therefore, new solutions to fire suppression are required and encouraged. Therefore, a new type of fire suppression system is needed.

Thus, there is a need in the art to provide a fire protection/suppression system for fire extinguishment without the limitations inherent in present methods.

### SUMMARY

The present invention is directed to an apparatus to amalgamate substances, particularly a fire protection/suppression system for fire extinguishment, which includes at least two substance holding tanks, an inert gas tank, an amalgamation mixing chamber, and a nozzle. The inert gas tank is in fluid communication with the at least two substance holding tanks such that when actuated, inert gas will further pressurize substances contained in the at least two substance holding tanks. The amalgamation mixing chamber is in fluid communication with the at least two substance holding tanks such that when actuated, the substances in the at least two substance holding tanks enter and mix in the amalgamation mixing chamber. The nozzle is in fluid communication with the amalgamation mixing chamber such that when actuated, the mixed substances in the amalgamated mixing chamber are discharged from the nozzle.

It is a feature of the invention to provide an apparatus to amalgamate substances that can replace existing Halon based fire extinguishing systems.

It is a feature of the invention to provide an apparatus to amalgamate substances that provides an engineered flow delivered at low pressure that uses a highly efficient process contained within a system for a desired application.

It is a feature of the invention to provide an apparatus to amalgamate substances that is a mixing device with two or more separate chambers of substances to achieve an engineered flow and to flow the entire mixture through one or more nozzles.

It is a feature of the invention to provide an apparatus to amalgamate substances that is separate, self contained or fixed for delivery of an engineered flow for a desired application or process under low pressure.

It is a feature of the invention to provide an apparatus to amalgamate substances that is a pressurized device that houses separate storage vessels that flow to a mixing chamber and the resultant mixture is discharged as an atomized combination of the stored substances through an atomizing or converging-diverging nozzle.

It is a feature of the invention to provide an apparatus to amalgamate substances that is a device that includes a mixing chamber for two or more substances and achieves a multi-phase mixture through at least one converging-diverging nozzle thereby effectuating efficient use of fully mixed agents.

### BRIEF DESCRIPTION OF THE DRAWINGS

These and other features, aspects and advantages of the present invention will become better understood with reference to the following description and appended claims, and accompanying drawing wherein:

FIG. 1 is an embodiment of the apparatus to amalgamate substances.

### DETAILED DESCRIPTION OF THE INVENTION

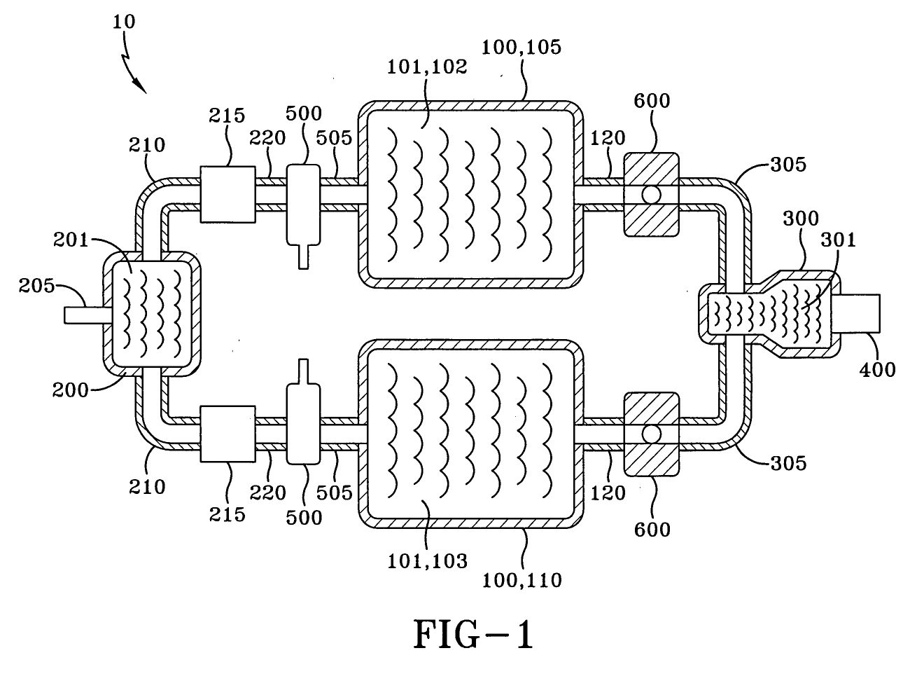

The preferred embodiment of the present invention is illustrated by way of example below and in FIG. 1. As seen in FIG. 1, the apparatus to amalgamate substances 10 includes at least two substance holding tanks 100, an inert gas tank 200, an amalgamation mixing chamber 300, and a nozzle 400. A substance may be defined, but without limitation, as any type of physical matter, agent or material which includes, but without limitation, fluids, liquids, gas, solids, any type of ingredient, chemical, item or any combination thereof. Each of the at least two substance holding tanks 100 may contain different substances. The inert gas tank 200 is in fluid communication with the at least two substance holding tanks 100 such that when initiated or actuated, inert gas 201 will further pressurize substances 101 contained in the at least two substance holding tanks 100. The amalgamation mixing chamber 300 is in fluid communication with the at least two substance holding tanks 100 such that when initiated or actuated, the substances 101 in the at least two substance holding tanks 100 enter and mix in the amalgamation mixing chamber 300. The nozzle 400 is in fluid communication with the amalgamation mixing chamber 300 such that when initiated or actuated, the mixed substances or mixture 301 in the amalgamated mixing chamber 300 is discharged from the nozzle 400.

In the discussion of the present invention, the invention will be discussed in a fire extinguishant environment; however, this invention can be utilized for any type of need that requires a combination of substances to be mixed and/or reacted, specifically, but without limitation, in the amalgamation of substances and the like. Examples in which the invention may be utilized include, but without limitation, decontamination kits, agricultural pesticide dispensers, food preparation, paint sprayers, and aerosol delivery of medication.

As seen in FIG. 1, the apparatus to amalgamate substances 10 includes at least two substance holding tanks 100. The substance holding tanks 100 may be completely enclosed. In one of the embodiments of the invention, one substance holding tank 105 may be used to hold a substance powder 102, particularly a chemical reactant. Another substance holding tank 110 may be used to hold a liquid chemical 103, particularly a flowing liquid chemical. For the fire extinguishing embodiment, the tank 110 holding the liquid chemical 103 may be engineered and ratioed to be twice the size of the tank 105 holding the substance powder 102. For fire extinguishing purposes, the substance powder 102 may be sodium bicarbonate or potassium bicarbonate while the liquid chemical 103 may be acetic acid. In other embodiments of the invention, there may be more than two substance holding tanks 100 in the apparatus to amalgamate substances 10.

In the preferred embodiment, and as seen in FIG. 1, substances 101 are added through filling chambers 500, and through piping or hoses 505 into the substance holding tanks 100, 105, 110. Additional filing chambers 500, piping 505 and substance holding tanks 100 may be added to obtain a desired result of amalgamation of more than two substances. As seen in FIG. 1, in the preferred embodiment, each substance holding tank 100 may have a corresponding filling chamber 500. Once the substance holding tanks 100 are filled to their desired levels, tank valves 600 keep the substances in their respective holding tanks until desired actuation.

A noble or an inert gas 201 may be used to pressurize the inert gas tank 200 or apparatus 10 through an inert gas tank valve 205. The inert gas 201 will travel through associated inert gas piping 210. In one of the embodiments of the invention, all the inert gas piping 210 has substantially the same or equal radius. The inert gas tank 200 may be in fluid communication with inert gas check valves 215. Inert gas check valves 215 are not needed in some applications, but are shown and illustrated for complete clarity. The inert gas check valves 215 may be in fluid communication with piping 220 which leads to the filling chambers 500 and/or substance holding tanks 100. When the inert gas check valves 215 are not used or are in the open position, inert gas 201 from the inert gas tank 200 will fill the substance holding tanks 100 and further pressurize the contained substances 101 in the substance holding tanks 100. For fire extinguishing purposes, the preferred inert gas 201 is nitrogen and is pressurized to about 20 to about 60 psi such that all substances contained in substance holding tanks 100 are evenly expelled.

In the preferred embodiment, once the system is pressurized, specifically the inert gas tank 200, operation results from actuation of the inert gas check valves 215 and the tank valves 600. If there are no valves in the apparatus 10 then initial pressurization will actuate operation of the apparatus 10. The inert gas check valves 215, the tank valves 600, or any series of valves may be used to regulate the flow of the separate substances 101 to the amalgamation mixing chamber 300. In the preferred embodiment, each substance holding tank 100 has a corresponding tank valve 600. These tank valves 600, as with any other valves used in the apparatus 10 may be operated automatically, manually, or utilizing any method practicable. Furthermore, the described valves as well as any other valves potentially used may start, stop or restart the apparatus 10 and/or its flow.

In operation, when the tank valves 600 and inert gas check valves 215 are actuated or opened, inert gas 201 starts to expand and push the substances 101, through piping 120, through the tank valves 600 and into designed ratioed amalgamation mixing chamber piping 305. In one of the embodiments, all the amalgamation mixing chamber piping 305 has substantially the same or equal radius. Substances 101 that were stored in the substance holding tanks 100 are now flowing by proper ratio through amalgamation mixing chamber piping 305 and into the amalgamation mixing chamber 300. The substance holding tanks 100 may also be ratioed and designed such that the entire contents (all the substances 101) will deplete upon actuation of the apparatus 10 and/or maximum system efficiency is achieved. In one of the fire extinguishment embodiments of the invention, amalgamation mixing chamber piping 305 and substance holding tanks 100 are ratioed such that the mixed substances or mixture 301 has a two to one ratio of acetic acid to bicarbonate. The amalgamation mixing chamber piping 305 and substance holding tanks 100 may be ratioed to achieve any desired ratio. After the substances 101 enter the amalgamation mixing chamber 300, a mixture 301 of the substances 101 is then created in the amalgamation mixing chamber 300 and is discharged through the nozzle 400. Only one nozzle 400 is shown, however, more nozzles can be utilized. The preferred nozzle 400 is a converging-diverging (C-D) nozzle. When the inert gas check valves 215 and the tank valves 600 are not used or are in the open position, initial pressurization of the apparatus 10 propels the stored substances 101 into the amalgamation mixing chamber 300, creating a mixture 301, which is then propelled out the nozzle 400.

The apparatus to amalgamate substances 10 may operate at low pressures, typically about 20 to about 60 psi may be used for pressurization. However, higher pressures may be used for quicker discharge times.

The apparatus to amalgamate substances 10 may be used as a hand held fire extinguisher or where a separate self-contained fire suppression system is required. As stated above it can be utilized in any system which requires the mixing of two or more substances. The invention may be in a self contained unit or part of a larger apparatus.

The method to amalgamate substances includes pressurizing contained substances via a noble or inert gas, actuating the contained substances such that the contained substances are mixed, then discharged through a nozzle. The substances are discharged by the apparatus 10 through a combination of initial pressure and gases produced by the mixing of the stored substances in the amalgamation mixing chamber 300.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment contained herein.

What is claimed is:

1. An apparatus for amalgamating substances, comprising:
at least two substance holding tanks;
an inert gas tank, the inert gas tank in fluid communication with the at least two substance holding tanks such that when actuated inert gas will pressurize substances contained in the at least two substance holding tanks;
an amalgamation mixing chamber, the amalgamation mixing chamber in fluid communication with the at least two substance holding tanks such that when actuated the substances in the at least two substance holding tanks enter and mix in the amalgamation mixing chamber creating a mixture of the substances; and
a nozzle, the nozzle in fluid communication with the amalgamation mixing chamber such that when actuated the mixture in the amalgamated mixing chamber is discharged from the nozzle.

2. The apparatus for amalgamating substances of claim 1, wherein the apparatus further comprises filling chambers for adding substances to the at least two substance holding tanks.

3. The apparatus for amalgamating substances of claim 2, wherein the nozzle is a converging-diverging (C-D) nozzle.

4. The apparatus for amalgamating substances of claim 3, wherein one of the substance holding tanks contains sodium bicarbonate, while the other substance holding tank contains acetic acid.

5. The apparatus for amalgamating substances of claim 4, wherein the inert gas tank contains nitrogen.

6. The apparatus for amalgamating substances of claim 3, wherein one of the substance holding tanks contains potassium bicarbonate, while the other substance holding tank contains acetic acid.

7. The apparatus for amalgamating substances of claim 6, wherein the inert gas tank contains nitrogen.

8. An apparatus for amalgamating substances, comprising:
two substance holding tanks, one of the substance holding tanks containing sodium bicarbonate, while the other substance holding tank containing acetic acid;
an inert gas tank, the inert gas tank in fluid communication with the two substance holding tanks such that when actuated inert gas will pressurize substances contained in the two substance holding tanks, the inert gas tank containing nitrogen;
an amalgamation mixing chamber, the amalgamation mixing chamber in fluid communication with the two substance holding tanks such that when actuated the substances in the two substance holding tanks enter and mix in the amalgamation mixing chamber creating a mixture of the substances; and
a converging-diverging (C-D) nozzle, the nozzle in fluid communication with the amalgamation mixing chamber such that when actuated the mixture in the amalgamated mixing chamber is discharged from the nozzle;
filling chambers for adding substances to the two substance holding tanks, the filling chambers in fluid communication with the two substance holding tanks;
ratioed amalgamation mixing chamber piping, the piping allowing fluid communication between the two substance holding tanks and the amalgamation mixing chamber.

9. The apparatus for amalgamating substances of claim 8, wherein the apparatus further comprising inert gas check valves, the inert gas check valves containing the inert gas in the inert gas tank until the inert gas is ready to be actuated.

10. The apparatus for amalgamating substances of claim 9, wherein the apparatus further comprising tank valves, the tank valves containing the substances in their respective substance holding tanks until the substances are ready to be actuated.

11. The apparatus for amalgamating substances of claim 10, wherein the apparatus further comprising engineered and ratioed tubing, the engineered and ratioed tubing allows the substances in their respective substance holding tanks to flow into the amalgamation mixing chamber at a desired and metered rate to create a back pressure in the amalgamation mixing chamber just upstream of the exit nozzle.

12. A fire protection/suppression system for fire extinguishment, the system comprising:
two substance holding tanks, one of the substance holding tanks containing sodium bicarbonate, while the other substance holding tank containing acetic acid;
an inert gas tank, the inert gas tank in fluid communication with the two substance holding tanks such that when actuated inert gas will pressurize substances contained in the two substance holding tanks, the inert gas being nitrogen;
inert gas check valves, the inert gas check valves containing the inert gas in the inert gas tank until the inert gas is ready to be actuated;
an amalgamation mixing chamber, the amalgamation mixing chamber in fluid communication with the two substance holding tanks such that when actuated the substances in the two substance holding tanks enter and mix in the amalgamation mixing chamber creating a mixture of the substances;
tank valves, the tank valves containing the substances in their respective substance holding tanks until the substances are ready to be actuated;
a converging-diverging (C-D) nozzle, the nozzle in fluid communication with the amalgamation mixing chamber such that when actuated the mixture in the amalgamated mixing chamber is discharged from the nozzle, the discharged mixture able to suppress fire;
filling chambers for adding substances to the two substance holding tanks, the filling chambers in fluid communication with the at least two substance holding tanks; and
ratioed amalgamation mixing chamber piping, the piping allowing fluid communication between the two substance holding tanks and the amalgamation mixing chamber, the system operating at about 20 to about 60 psi.
